(19) United States
(12) Patent Application Publication
(10) Pub. No.: US 2012/0145808 A1
(43) Pub. Date: Jun. 14, 2012

(54) METHOD AND APPARATUS FOR VARIABLE EXHAUST NOZZLE EXIT AREA

(75) Inventors: Chad M. Winkler, Glen Carbon, IL (US); Andrew J. Dorgan, Edwardsville, IL (US); Eric L. Werner, Saint Charles, MO (US)

(73) Assignee: THE BOEING COMPANY, Chicago, IL (US)

(21) Appl. No.: 12/968,106

(22) Filed: Dec. 14, 2010

(51) Int. Cl. F02K 1/00

(52) U.S. Cl. 239/265.35

(57) ABSTRACT

A nozzle effective exit area control system is created with a convergent-divergent nozzle with a divergent portion of the nozzle having a wall at a predetermined angle of at least 12° from the freestream direction. Disturbance generators are located substantially symmetrically oppositely on the wall to induce flow separation from the wall with the predetermined wall angle inducing flow separation to extend upstream from each disturbance generator substantially to a throat of the nozzle pressurizing the wall and reducing the effective area of the jet flow at the nozzle exit.

### REFERENCE TO RELATED APPLICATIONS

This application is copending with U.S. patent application Ser. No. 12726605 filed on Mar. 18, 2010 entitled METHOD AND APPARATUS FOR NOZZLE THRUST VECTORING the disclosure of which is incorporated herein by reference as though fully set forth.

### BACKGROUND INFORMATION

1. Field

Embodiments of the disclosure relate generally to the field of area control of jet engine nozzle exhaust and more particularly to embodiments for inducing, flow separation in the divergent section of an exhaust nozzle to symmetrically alter the effective divergence angle of the nozzle walls to alter effective exit area.

2. Background

Exhaust nozzle exit area (A9) control for jet engines enhances engine and aircraft performance. With additional requirements for increased maneuverability and performance of modem jet aircraft as well as survivability requirements, fixed. geometry nozzle systems which provide for exit area control including vectored thrust systems have become important in achieving overall performance goals. Exit area control allows tailoring of engine performance for thrust optimization. Mechanical systems often use deflecting surfaces to physically alter nozzle shape and area. Mechanical control of the throat area has been attempted before (see U.S. Pat. No. 2,846,843 to Clark et al, entitled “Variable area convergent-divergent exhaust nozzle and control therefor”) which does control the expansion ratio, but with a resulting change in the nozzle flow rate.

Fluidic systems have been employed but typically affect nozzle throat area or result in the generation of shocks in the divergent section which may be undesirable. Fluidic throat area control has been performed by as disclosed in U.S. Pat. No. 5,996,936 to Mueller entitled “Fluidic throat exhaust nozzle”, and suffers the same problem of nozzle flow rate variation with a change in expansion ratio.

It has been attempted to control A9 with layers of combustible material which burn off during flight to give variable A9. See U.S. patent application Ser. No. 09/942,238 to Hawkins and Murdock entitled “Combustible outgassing material lined altitude compensating rocket nozzle”. However, it is not always desirable to have combustion occurring on the walls of a nozzle. Nor do combustibles allow cyclic changes of area control during a flight mission as the combustibles can only be used once.

A combined, system as disclosed in U.S. Pat. No. 3,010,280 to Hausmann et al entitled “Variable-expansion nozzle” employs blowing combustible mixtures into the divergent section to occupy flow area, thus reducing the overall nozzle exit area, Again, it is not always permissible to use combustibles near the walls of a nozzle due to material limitations.

Mechanical systems are heavy due to the requirements for large control surfaces and actuators. Large amounts of injected flow in fluidic systems are not preferable due to the performance impact on the engine to supply the large amounts of secondary flow for injection (flow that could otherwise be used to produce thrust).

It is therefore desirable to avoid the weight penalties of mechanical nozzle exit area adjustment systems by providing effective exit area control. It is also desirable to provide effective exit area control which does not impact the nozzle throat area, thus easily maintaining the engine mass flow. Additionally, it is desirable to provide effective exit area control which is simple to implement and minimizes thrust losses.

### SUMMARY

The disclosed embodiments provide a nozzle with a divergent portion having a divergent wall at a predetermined angle of at least 12° from the streamwise nozzle axis direction. Disturbance generators are located substantially symmetrically opposite on the divergent wall to induce flow separation where the predetermined wall angle is sufficient for the induced flow separation to extend upstream from disturbance generator substantially to the throat of the nozzle. This pressurizes the divergent walls and reduces the effective area of the exhaust flow at the nozzle exit. In certain example embodiments the convergent-divergent nozzle has a total angle no greater than 150 degrees.

For one embodiment the disturbance generator is an injection flow slot which may be located at least 50% of a divergence length from the throat of the nozzle to a trailing edge of the nozzle for certain engine and aerodynamic conditions or between 25% and 75% of a divergence length for alternative conditions. If the nozzle has sufficient structural depth, the injection may be performed at or near 100% of the divergence length. Injection flow through the injection slot is controlled between 0% and 4% of total flow for effective area control of the jet flow in the nozzle.

In certain example embodiments the convergent-divergent nozzle is a rectangular or two-dimensional (2D) nozzle having a first injection flow slot on a lower wall of the nozzle and a symmetrical injection flow slot on an upper wall of the nozzle.

In yet other embodiments the convergent-divergent nozzle is a three-dimensional (3D) nozzle having multiple injection flow slots arranged circumferentially around the divergent portion of the nozzle.

In operation the embodiments create a method for exit area reduction by providing a convergent-divergent nozzle with a total angle of less than 150° and a divergence angle of at least 10′ (considering sonic nozzle operating conditions permit the separation effect with as little as 10′ of divergence), but preferably 12′ or greater with symmetrical disturbance generators located at predetermined locations on opposing surfaces of a divergent portion of the nozzle. Magnitude of the disturbance created by the disturbance generators is controlled to create non-shock induced flow separation from a wall of the divergent portion. The predetermined location of the disturbance generator is defined to create a flow separation zone extending substantially from the nozzle throat to the nozzle trailing edge and the magnitude of the disturbance is controlled to create the flow separation zone with a magnitude to induce a desired reduction in effective exit area (AE9).

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1 is side cross section view of an example embodiment with a 2D Nozzle;

FIG. 2 is a side view diagram of angular relationships of convergent and divergent portions of the nozzle of FIG. 1;

FIGS. 3A-3C are side views of representations of the flow field from a Computational Fluid Dynamics (CFD) solution for the 2D nozzle with no secondary flow, 2.6% secondary flow and 7.6% secondary flow;

FIG. 4 is a graph of thrust coefficient created by injected, flow in the 2D nozzle represented in FIGS. 3A-3C;

FIG. 5 is a partial section isometric view of an example 3D nozzle embodiment; and,

FIG. 6 is a flow chart depicting operation of the example nozzle for exit area control.

### DETAILED DESCRIPTION

The embodiments described herein demonstrate effective exit area control employing a nozzle which has a convergent and divergent cross section. The divergent portion incorporates walls at an angle which is steeper than normally used in conventional nozzle designs. The steeper wall is then exploited to efficiently generate flow separation when a disturbance is introduced on the wall. Inducing flow separation in the divergent section of the nozzle fluidically changes the divergence angle of the flow from the wall in a two-dimensional (2D) nozzle or comparable structure in a three-dimensional (3D) nozzle. This results in a reduction in area of the exhaust flow as the effective shape of the divergent jet in the nozzle is separated from the wall. The disturbance which causes separation can be a fluidic jet, pulsed jet, or synthetic jet such as a vibrating membrane or sonic impulse with no net mass flux or other method to produce a disturbance to cause separation of the jet flow from the wall. The wall angle is such that the separation travels upstream from the disturbance (jet) to just aft of the throat. This pressurizes the entire wall, giving a net flow separation from the wall with a commensurate reduction in effective area of the exhaust flow at the exit of the nozzle. No shock is generated in the divergent section, the sonic line remains undisturbed and the throat area remains constant.

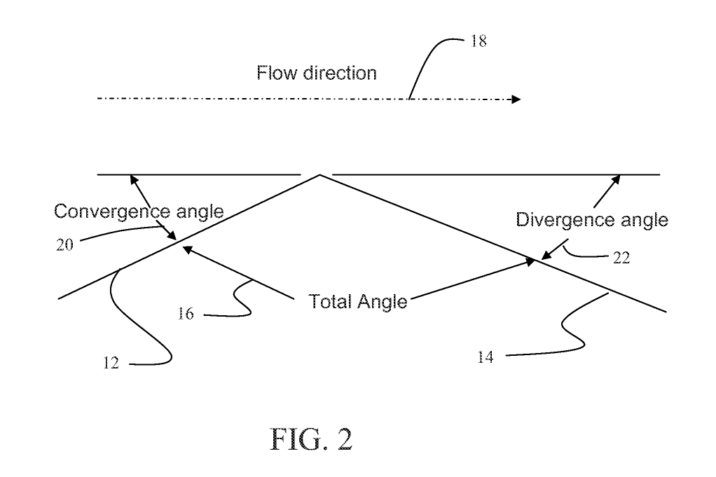

Referring to the drawings, FIG, 1 shows an embodiment having a side cross section of a nozzle 10 with a convergent inlet portion 12 and a divergent outlet portion 14. As represented in FIG. 2, the total angle 16 between the convergent inlet portion and divergent outlet portion is less than or equal to 150°. With respect to a streamwise nozzle axis represented by arrow 18, the convergence angle 20 of the inlet portion is greater than 18° and the divergence angle 22 of the outlet portion is greater than 12°. The exact angles will be chosen by the designer taking into account the maximum area change desired as well as the desired expansion ratio and mass flow rates of the nozzle. Greater divergent antes will generally lead to greater divergence of the jet from the nozzle walls and greater reduction in AE9. In most embodiments, the convergent angle will be steeper than the divergent angle. Divergent angles substantially less than 12 degrees will typically result in shock waves when injection is performed and are not appropriate for the current embodiments. The exact angle of shock onset is dependant upon many factors such as expansion ratio and pressure, and the values employed in the embodiments disclosed herein are typical.

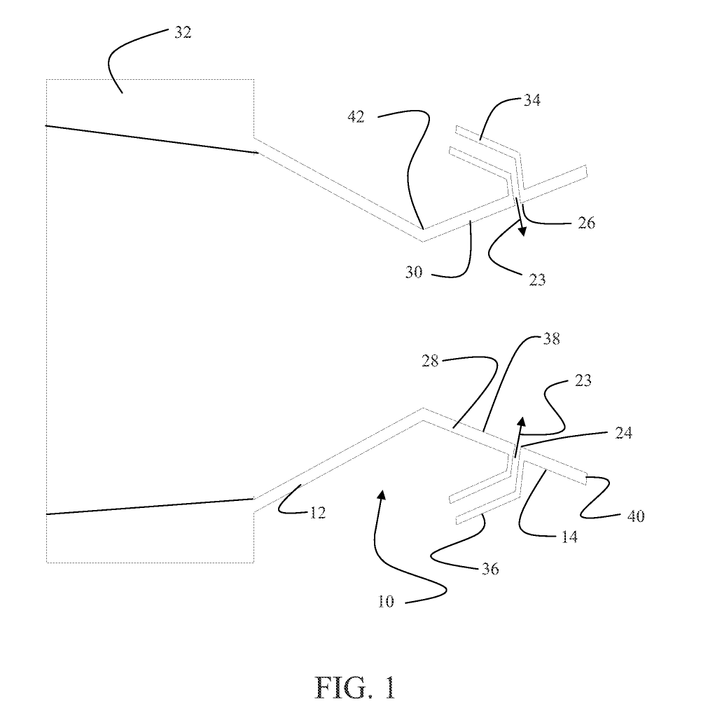

Returning to FIG. 1, flow disturbance in the divergent outlet portion 14 is created in the embodiment shown using fluidic jets (represented by arrows 23) introduced through flow slots 24 and 26 on the lower and upper nozzle surfaces 28 and 30 respectively. Slot 26 is substantially symmetrically opposite slot 24 with respect to the streamwise nozzle axis for symmetrical divergence of flow from the walls. Injection flow is provided by engine bleed or other diverted flow from an engine 32 through ducts 34 and 36. Dimensions of the slots and ducts are not to scale and have been exaggerated for clarity. The injection location is determined based. upon the particular nozzle configuration. In most embodiments, the injection location will be between the midpoint 38 and trailing edge 40 of the divergent outlet portion. Injection locations further upstream may be beneficial to some applications and a nominal range of 25% to 75% of divergence length is anticipated for optimum operation. However, where structural depth to accommodate necessary plumbing is present in the nozzle, injection at 100% of the divergence length may be employed.

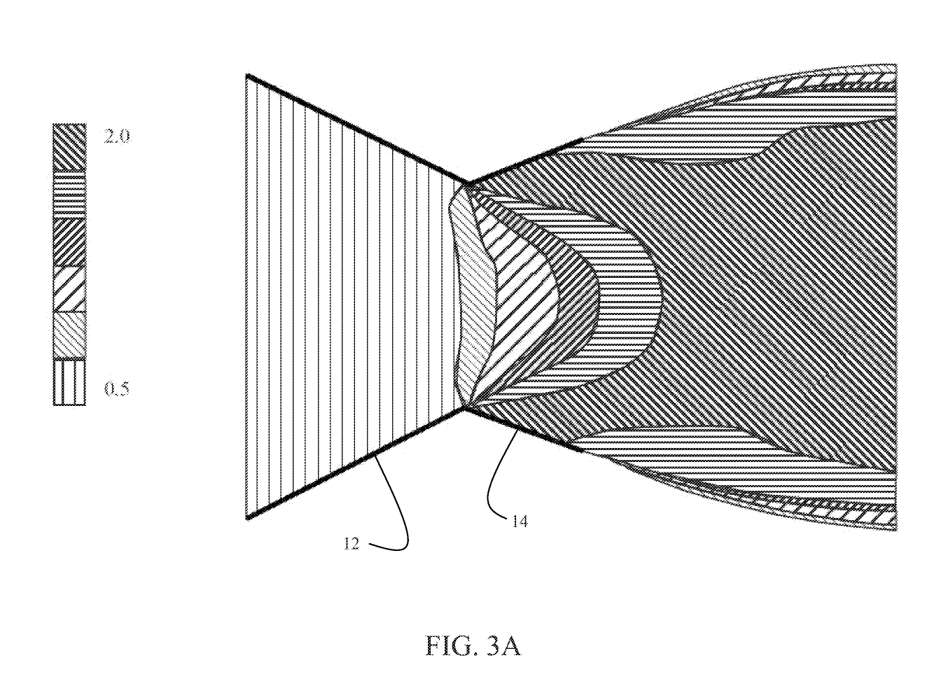

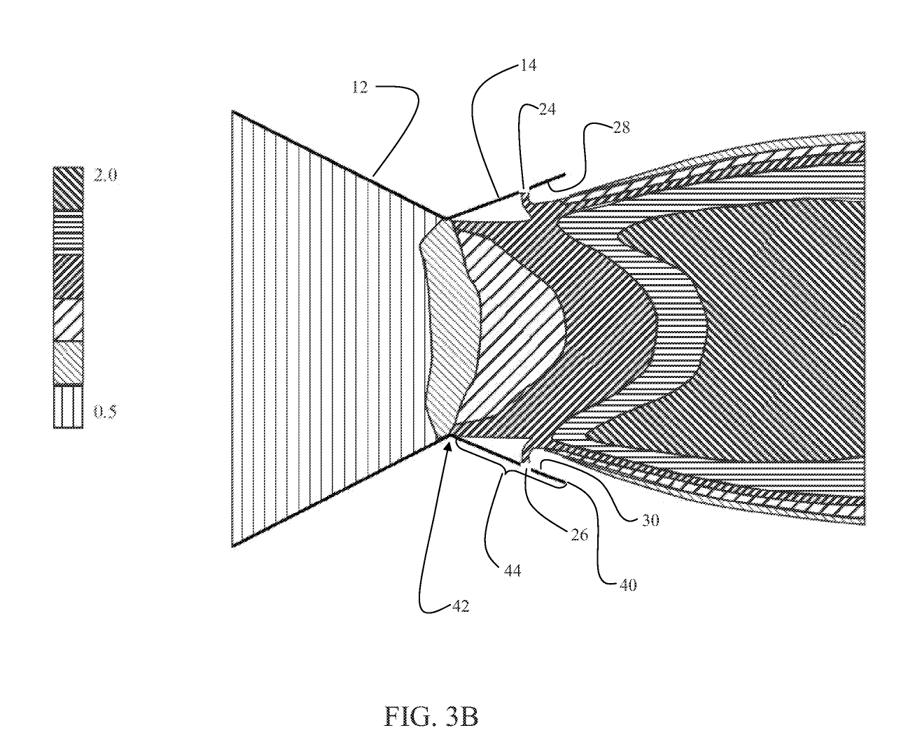

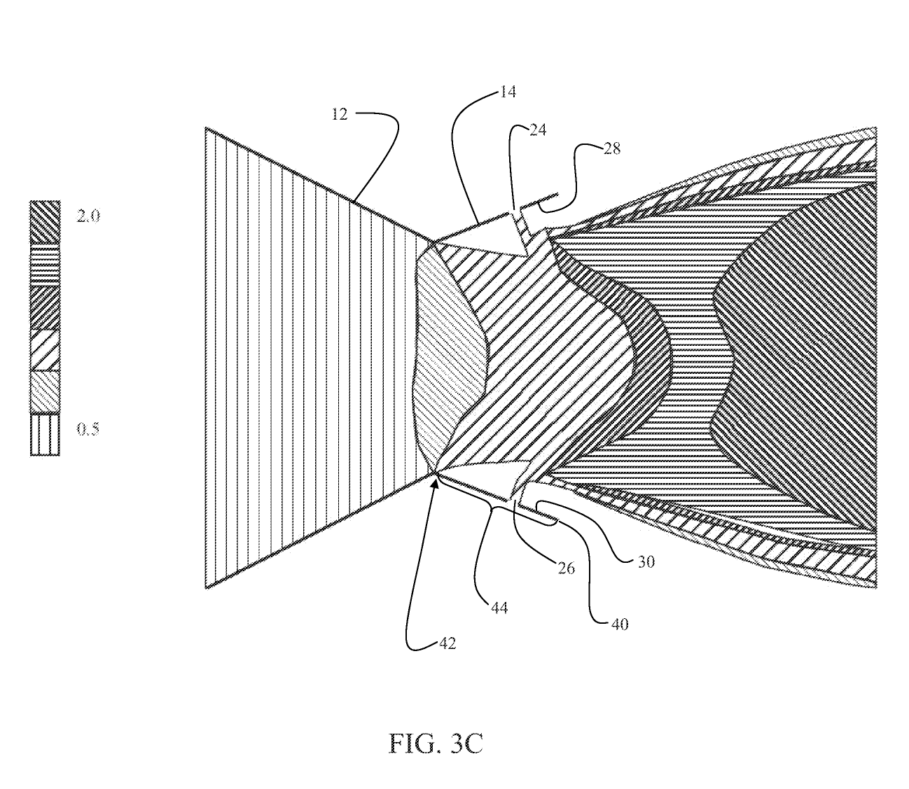

For an example of demonstration of operation of the disclosed embodiment, FIGS. 3A-3C are a representation of the flow field from a Computational Fluid Dynamics (CFD) solution for the 2D nozzle of the embodiment having a nozzle pressure ratio (NPR) of 5 (which is near the design condition for this nozzle) with varying injection flow described in greater detail subsequently. The Mach profile of the flow is shown in graded contours represented by the hatching in the flow field from Mach 0.5 to Mach 2.0. The fluidic injection takes place on surfaces 28 and 30 in the divergent section through slots 24 and 26. The flow separates aft of the throat 42 and the flow separation zone 44 persists to the exit aperture at the trailing edge 40 of the nozzle thus altering the effective exit area AE9. No shock is formed from including the divergent wall injector since the separation begins just aft of the throat where the Mach number is unity. This concept effectively alters the divergence angle of the nozzle. Increasing injection flow results in an increasing change in effective exit area progressing from FIG. 3A with a lower injection flow to FIG. 3C with highest injection flow.

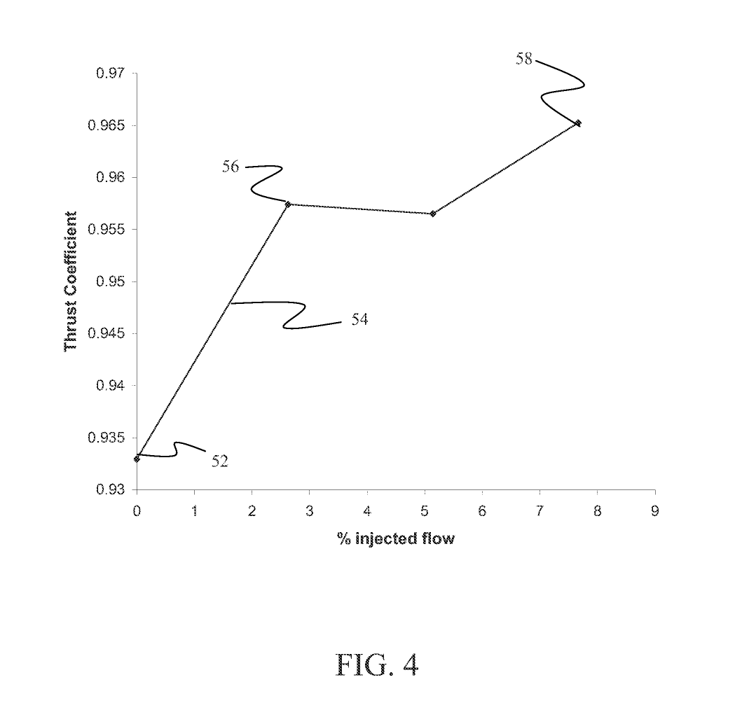

Referring to FIG. 4 in conjunction with FIGS. 3A-3C, with injected flow described as a percent of total flow through the nozzle (% injected flow), with no injected flow, the nozzle exit area A9 results in a thrust coefficient of 0.933 as represented by point 52 on trace 54 and shown in FIG. 3A. A 2.6% injected flow (total injection from summing both injectors) through slots 24 and 26 results in a reduction in exit area providing a thrust coefficient of 0.957 as represented by point 56 and shown in FIG. 3B. Increasing the injected flow to 7.6% results in area AE9 change for a thrust coefficient of 0.965 as represented by point 58 and shown in FIG. 3C. The optimum amount of injection will depend on nozzle configuration, and the trend in thrust coefficient with injection flow is nonlinear. Injected flow in the range of 0-10% is anticipated for AE9 control through a desired performance range.

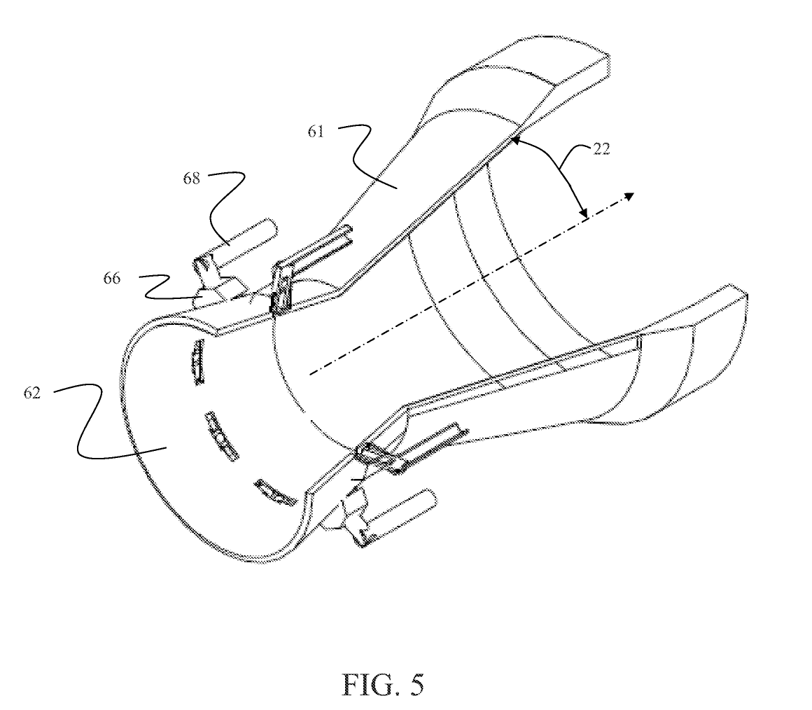

While examples previously provided herein are for 2D nozzles, three dimensional (3D) nozzles employing the apparatus and method may be embodied as shown in FIG. 5. The convergent inlet portion 61 and divergent outlet portion 62 of nozzle 64 have corresponding geometric relationships to the 2D embodiments described with a total angle of less than 150° created by convergence angle of the inlet portion is greater than 18° and divergence angle 22 of the outlet portion greater than 12°. Multiple injection inlets 66 with associated feed conduits 68 are provided around the circumference of the diverging outlet portion of the nozzle. Eight inlets at 45° spacing are shown as examples. However, four inlets at 90° spacing or a greater number of inlets for refined control of wall separation by the jet may be employed. Multiple sets of injection inlets may be spaced along the length of the diverging outlet portion to accommodate multiple design operating conditions of the jet.

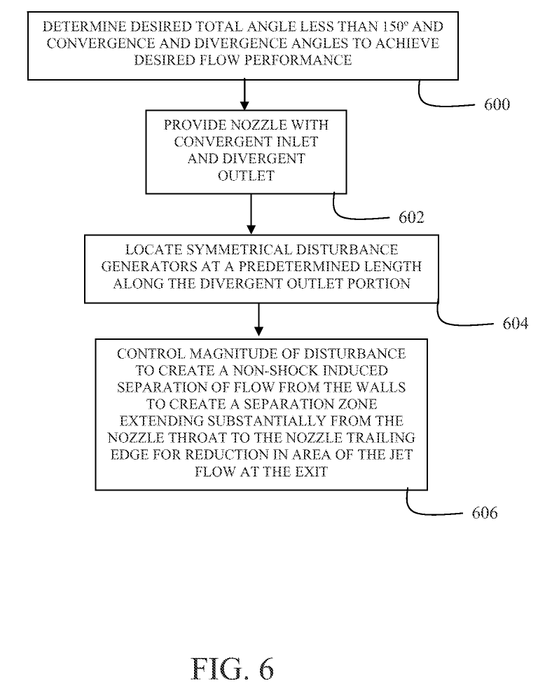

Operation of the embodiments disclosed herein is summarized in FIG. 6. A nozzle with convergent inlet and divergent outlet is provided in step 802 with preliminary determination of a desired total angle and convergence and divergence angles to achieve desired flow performance in step 800. Disturbance generators such as inlet flow slots, vibrating membranes or sonic impulse generators are located substantially symmetrically oppositely at a predetermined length along the divergent outlet portion of the nozzle in step 804 and the magnitude of the disturbance created. by the generators is controlled to create a non-shock induced separation of the flow from the wall of the divergent outlet portion to create a separation zone extending substantially from the nozzle throat to the nozzle trailing edge of a magnitude to create a reduction in effective area of the jet flow at the nozzle exit in step 806. A feedback control loop would then be implemented to monitor the current exit flow area and the desired effective exit flow area. The feedback controller would increase/decrease injection to increase/decrease the nozzle effective exit flow area, respectively.

Having now described, various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A nozzle effective exit area control system comprising:
a convergent divergent nozzle having a divergent portion wall at a predetermined angle of at least 12° from a streamwise nozzle axis; and,
at least two disturbance generators located in substantially symmetric opposition on the divergent wall to induce flow separation from the divergent wall;
said predetermined divergent wall angle inducing flow separation to extend upstream from the at least two disturbance generators substantially to a throat of the nozzle pressurizing the divergent portion wall and creating a reduction in flow area through an exit of the nozzle.

2. The nozzle effective exit area control system of claim 1 wherein a convergent portion of the nozzle has a wall at a predetermined angle of at least 18°.

3. The nozzle effective exit area control system of claim 1 wherein the disturbance generators are an injection flow slot.

4. The nozzle effective exit area control system of claim 3 wherein the injection flow slots are located at least 50% of a divergence length from the throat of the nozzle to the exit of the nozzle.

5. The nozzle effective exit area control system of claim 3 wherein the injection flow slots are located between 25% and 75% of a divergence length from the throat of the nozzle to the exit of the nozzle.

6. The nozzle effective exit area control system of claim 3 wherein injection flow through the injection slot is controlled between 0% and 10% of total flow.

7. The nozzle effective exit area control system of claim 3 wherein the convergent-divergent nozzle is a 2D nozzle and said at least two disturbance generators comprise a first injection flow slot on a lower divergent wall of the nozzle and a second injection flow slot on an upper divergent wall of the nozzle.

8. The nozzle effective exit area control system of claim 3 wherein the convergent-divergent nozzle is a 3D nozzle and said at least two disturbance generators comprise a plurality of injection flow slots arranged circumferentially around the divergent portion of the nozzle.

9. An effective exit area control system for a nozzle comprising:
a convergent-divergent nozzle having a total angle no greater than 150 degrees;
a divergent portion of the nozzle with a wall having a predetermined angle of at least 12° from a streamwise nozzle axis; and,
a first injection flow slot on the divergent portion of the nozzle and a second injection flow slot on the divergent portion of the nozzle substantially opposite the first slot with respect to the axis, each controlled between 0% and 4% of total flow to induce flow separation from the wall;
said predetermined, angle of the divergent portion wall inducing flow separation to extend upstream from the first and second injection flow slots substantially to a throat of the nozzle pressurizing the divergent portion wall and. creating a reduction in flow area through an exit of the nozzle.

10. The effective exit area control system for a nozzle as defined in claim 9 wherein each of the first and second injection flow slots is located at least 50% of a divergence length from the throat of the nozzle to a trailing edge of the nozzle.

11. The effective exit area control system for a nozzle as defined in claim 9 wherein each of the first and second injection flow slots is located between 25% and 75% of a divergence length from the throat of the nozzle to a trailing edge of the nozzle.

12. A method for nozzle exit area control comprising:
providing a convergent-divergent nozzle with a divergence angle of at least 12°;
locating a pair of disturbance generator at predetermined locations substantially symmetrically opposite on a divergent portion of the nozzle; and,
controlling a magnitude of a disturbance created by the disturbance generators to create non-shock induced flow separation from the divergent portion.

13. The method of claim 12 wherein said predetermined locations of the disturbance generators are defined to create a flow separation zone extending substantially from a nozzle throat to a nozzle trailing edge.

14. The method of claim 12 wherein the step of controlling the magnitude of the disturbance further includes creating a flow separation zone to induce a desired nozzle exit area reduction.

15. The method of claim 12 wherein the step of locating a pair of disturbance generators comprises providing injection flow slots on opposing walls of the divergent portion.

16. The method of claim 15 wherein the step of providing injection flow slots includes locating the flow injection slots at least 50% of a divergence length from a throat of the nozzle to a trailing edge of the nozzle.

17. The method of claim 15 wherein the step of providing injection flow slots includes locating the flow injection slots between 25% and 75% of a divergence length from a throat of the nozzle to a trailing edge of the nozzle.

18. The method of claim 15 wherein the step of controlling the magnitude of the disturbance comprises injecting a flow of between 0% and 10% of total flow through the slots.

19. The method of claim 12 wherein the step of locating disturbance generators comprises locating vibrating membranes on opposing walls of the divergent portion.

20. The method of claim 12 wherein the step of locating disturbance generators comprises locating sonic impulse generators on opposing walls of the divergent portion.
